(19) United States
(12) Patent Application Publication
(10) Pub. No.: US 2025/0237093 A1
(43) Pub. Date: Jul. 24, 2025

(54) Locking Mechanism with Anti-Rotation

(71) Applicant: Zeal Innovation Ltd, Swansea (GB)

(72) Inventor: Neil Anthony BARRON, Swansea (GB)

(21) Appl. No.: 18/853,350

(22) PCT Filed: Mar. 31, 2023
(86) PCT No.: PCT/GB2023/050869

§ 371 Date: Oct. 1, 2024

(30) Foreign Application Priority Data
Apr. 1, 2022 (GB) 2204829.2

(51) Int. Cl. E05B 67/06; E05B 71/00

(52) U.S. Cl. CPC E05B 67/063; E05B 71/00

(57) ABSTRACT

A locking device comprises a shackle having a body portion and legs extending therefrom with distal ends each having a foot portion; a tubular housing having an internal cavity and spaced first openings in the wall thereof on one side, the openings being adapted to receive the foot portion of the legs in a shackle hold position; and a mechanism for locking the foot portions in the hold position. Each foot portion has an anti-rotation portion of non-circular cross section, and a plate held within the housing cavity having an opening of matching non-circular cross section is aligned with each of the respective first openings for receiving the anti-rotation portion of a foot portion in the shackle hold position, two sides of which plate engage the inner wall of the housing to restrict its rotation about the axis of said foot portion. Each shackle leg will normally have a tip portion at the distal end of the foot portion and in some embodiments the wall of the tubular housing has second openings in the wall thereof opposite and aligned with the first openings.

This invention relates to locking mechanisms and particularly but not exclusively to hoop locks also known as D-locks or U-locks of the kind used to secure cycles and motorcycles. Such locks have a shackle with legs that are received and locked in an housing to secure a cycle for example to a permanent structure.

Hoop locks have been in use for a considerable time and have been very successful. Examples are described in U.S. Pat. Nos. 5,372,019; 5,398,529 and 7,389,659, and in European Patent Nos. 3,183,405 and 3,584,394 to which reference is directed. Reference is also directed to European Patent No. 3,707,325 which discloses another shackle lock construction. These Patents are specifically directed at the provision of features which prevent or at least restrict rotation of the legs of a shackle in a hoop lock when held in the locking housing. The present invention is directed at an improved lock structure for preventing or restricting such rotation.

According to the present invention a locking device comprises a shackle having a body portion and legs extending therefrom with distal ends each having a foot portion; a tubular housing having an internal cavity and spaced first openings in the wall thereof on one side, the openings being adapted to receive the foot portion of the legs in a shackle hold position; and a mechanism for locking the foot portions in the hold position. Each foot portion has an anti-rotation portion of non-circular cross section, and a plate held within the housing cavity having an opening of matching non-circular cross section is aligned with each of the respective first openings for receiving the anti-rotation portion of a foot portion in the shackle hold position, two sides of which plate engage the inner wall of the housing to restrict its rotation about the axis of said foot portion. Each shackle leg will normally have a tip portion at the distal end of the foot portion and in some embodiments the wall of the tubular housing has second openings in the wall thereof opposite and aligned with the first openings. With these features the tip portions extend into or through the second openings in the shackle hold position. Where the shackle legs do not have tip portions the foot portions are received in or through the first openings to engage the anti-rotation portion in the matching opening of the body in the housing and the foot portions can therefore extend toward the opposite side of the housing without engagement therewith.

It will be understood that the cross section of the foot portion beyond the anti-rotation portion, including the tip portion if included, cannot exceed that of the anti-rotation portion.

The cross section of the tubular housing is normally substantially circular, but this is not essential. Polygonal, such as square or rectangular cross sections can be used, and in some embodiments this can simplify the installation and/or location of the plate or plates; for example between two parallel sides. However, in preferred embodiments of the invention at least the internal cross section is circular and the or each plate has a lateral dimension that matches the internal diameter of the housing.

There does not have to be an exact match between the cross section of each anti-rotation portion and the respective opening in the aligned plate. In the context of the present Application the match must be sufficient to prevent or substantially prevent rotation of the anti-rotation portion in the respective opening. This can be accomplished for example by the respective cross sections just having two parallel sides. The same applies to the engagement of the plate or plates with the housing inner wall where a loose fit can be sufficient so long as rotation is restricted. In some embodiments however, the plate or plates can be permanently attached to the housing wall.

A separate plate with the matching non-circular opening can be aligned with each first opening for receiving the anti-rotation portion of the foot portion, but in some embodiments a single plate body has both matching non-circular openings. This can simplify installation of the plate body, but does use space that can be used to accommodate a locking mechanism unit. In preferred embodiments the or each plate body is housed in such a locking mechanism unit. The or each plate engages or abuts against the inner wall of the tubular housing to prevent its rotation. However, the or each plate may be secured separately within the housing. The cross section of the anti-rotation portion of the foot portion and the matching opening in the body can take any suitable form. In a preferred form it has two parallel sides created by cutting away from the foot portion of the respective leg, but a single cut away section may be sufficient. Other more complex cross sections can of course be used.

In a variant of the invention only one of the leg portions has an anti-rotation portion and a plate having only one opening of matching cross section is held within the housing. The other leg foot portion is fitted or installed in the housing by other means such a hinge or angled fitting that prevents or inhibits rotation relative thereto.

Locking mechanisms used in the present invention are normally disposed in the housing cavity with access for a key or code located either between the second openings or at an end of the housing. A typical mechanism has a deadbolt movable within the housing to engage a groove or notch in the foot portion of one or each leg. The anti-rotation portion of the respective foot can be located adjacent the groove or notch, and this can facilitate operation of such a locking mechanism. In embodiments of the invention where each foot portion extends to a tip portion, it is preferred that the anti-rotation portion is between such a groove or notch and the tip portion. Suitable locking mechanisms are disclosed in the Patent Specifications referred to above.

The invention will now be described by way of example and with reference to the accompanying schematic drawings wherein:

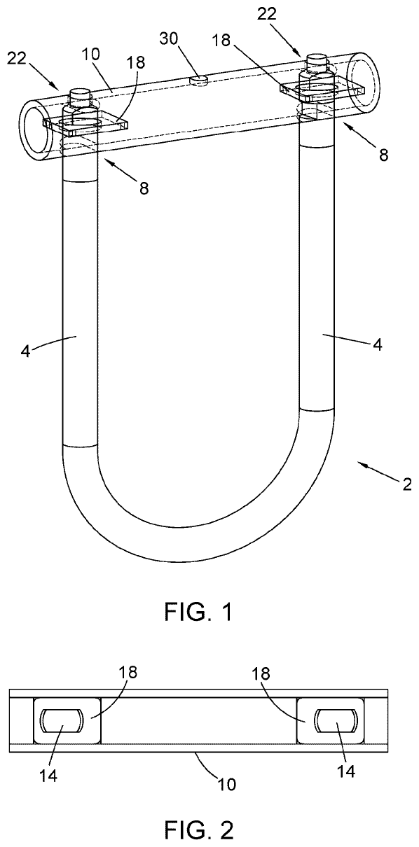

FIG. 1 shows a partly broken perspective view of a locking device according to the invention with the locking mechanism omitted;

FIG. 2 is a cross section taken on line A-A in FIG. 1;

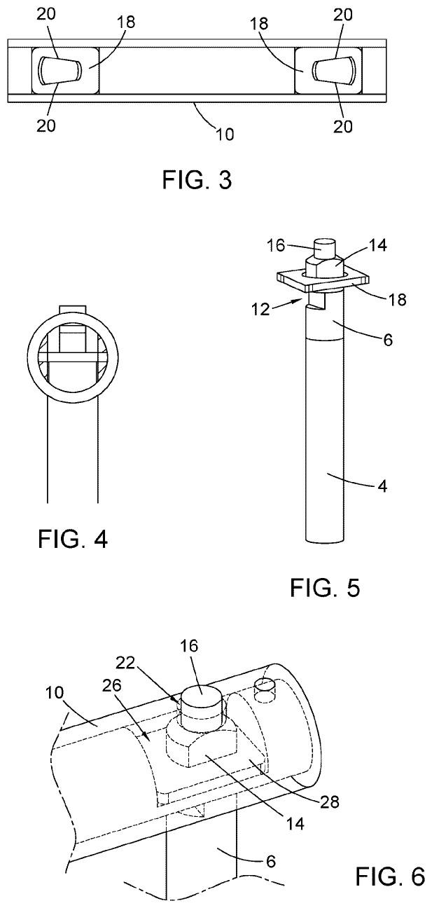

FIG. 3 is a view similar to that of FIG. 2 but illustration an alternative cross section of the anti-rotation portions of the leg feet;

FIG. 4 is a view of an end of the tubular casing in FIG. 1;

FIG. 5 shows the end of a shackle leg with an anti-rotation plate mounted thereon; and

FIG. 6 shows how an anti-rotation body may be held in a unit within the tubular housing of a device according to the invention.

The device shown in FIG. 1 is a hoop lock in which a shackle 2 has two legs 4 extending therefrom. The ends of the legs 4 form foot portions 6 which extend through first openings 8 into a tubular housing 10 of circular cross section which contains a locking mechanism (not shown). Each foot portion 6 has formed therein a groove or notch 12; an anti-rotation portion 14, and a tip portion 16 as better shown better in FIG. 5. Within the housing 8 are located bodies in the form of plates 18, each of which has an opening matching that of the anti-rotation portion 14 of the respective foot portion.

As can be seen from FIG. 2 the cross sections of the anti-rotation portions 14 and the openings in the plates 18 have parallel longer sides aligned with the axis of the housing 8. The spacing between these longer sides substantially matches the internal diameter of the housing 8 with the consequence that each plate 18 can only be located on a diameter of the housing as shown in FIG. 4. To hold it in place therefore only the axial position of each plate in the housing and its angular orientation need to be established. Rotation about the axis of a foot portion received therein is prevented or restricted by the housing wall. It will be appreciated that only the parallel sides of the anti-rotation portions 14 and the openings in the plates 18 that must match. The spacing between the other sides can be different provided of course the openings can accommodate the anti-rotation portions. FIG. 3 shows anti-rotation portions 14 in plates 18 in which the matching cross sections of the anti-rotation portions 14 and the openings in the plates 18 have straight converging sides 20. It will be noted that in each case the cross section of the anti-rotation portion 14 is within that of the foot portion 6. Indeed, in each embodiment illustrated the anti-rotation portions have been formed by cutting away sections of the foot portions 6.

While the embodiment illustrated includes two plates 18 restricting rotation of the foot portions 6, it will be appreciated that a single plate with two openings could be used. Such a plate could be part of a lock mechanism disposed within the housing 10.

As shown in FIG. 1 the tip portions 16 project through second openings 22 in the wall of the housing 10. The cross section of each tip portion 16 is less than that of the respective anti-rotation portion 14, and that illustrated is circular. The tip portions 16 can be no more than loose fits in the second openings 22 to assist in alignment of the foot portions 6 traversing the housing 10, but a tighter fit can be more secure.

A device according to the invention will include a lock mechanism which will normally be wholly within the tubular housing of the device. FIG. 6 shows how such a mechanism 24 can be contained within the housing 10 of the device shown in FIG. 1. The mechanism is a tubular construction that fits in the housing 10 and has a cut away section 26 in which sits a plate 28. The plate 26 has an opening aligned with the first (8) and second (22) openings for receiving the foot (6) and tip (16) portions of a shackle leg 4. The lock mechanism extends substantially the length of the housing 10 to hold a plate 26 in a section 24 aligned with each pair of first and second openings in the housing wall. FIG. 1 shows a keyhole 30 for operating such a lock mechanism.

Components of devices according to the invention will normally be metal; typically steel, but other suitably strengthened and/or hardened materials might be used. The components will normally be painted or coated, or enclosed in a protective plastic cover for ease of handling.

1. A locking device comprising a shackle having a body portion and legs extending therefrom with distal ends each having a foot portion; a tubular housing having an internal cavity and spaced first openings in the wall thereof on one side, the openings being adapted to receive the foot portion of the legs in a shackle hold position, wherein each foot portion has an anti-rotation portion of non-circular cross section; a plate within the housing cavity having an opening of matching non-circular cross section aligned with each of the respective first openings for receiving the anti-rotation portion of a foot portion in said hold position, two sides of which plate engage the inner wall of the housing to restrict its rotation about the axis of said foot portion; and a mechanism for locking the foot portions in the hold position.

2. The locking device according to claim 1, wherein each leg has a tip portion at the distal end of the foot portion, and the wall of the tubular housing has second openings in the wall thereof opposite and aligned with the first openings, the tip portions extending into the second openings in the shackle hold position.

3. The locking device according to claim 2, wherein the Locking-locking mechanism comprises a deadbolt selectively movable within the housing to engage a groove extending laterally in a foot portion of a shackle leg.

4. The locking device according to claim 3, wherein the anti-rotation portion is between the tip portion and the groove.

5. The locking device according to claim 3, wherein the cross section of the tip portion of each leg is smaller than that of the foot portion.

6. The locking device according to claim 3, wherein the cross section of each leg foot and tip portion is circular.

7. The locking device according to claim 1, wherein a single said plate has two said matching openings aligned with the foot openings for receiving the anti-rotation portions of the foot portions.

8. The locking device according to claim 1, wherein a separate said plate is aligned with each foot opening for receiving the anti-rotation portion of the respective foot portion.

9. The locking device according to claim 1, wherein two sides of the or each plate engage the inner housing wall.

10. The locking device according to claim 9, wherein the or each plate has two parallel sides engaging the inner wall of the housing.

11. The locking device according to claim 10, wherein the or each plate has a maximum lateral dimension substantially equal to the internal diameter of the housing.

12. The locking device according to claim 1, wherein the or each plate is secured within the housing.

13. The locking device according to claim 1, wherein the locking mechanism is a unit disposed in the housing cavity and the or each plate is housed within the locking mechanism unit.

14. The locking device according to claim 1, wherein the matching non-circular cross sections of the anti-rotation portion and the plate have parallel sides.

15. The locking device according to claim 1, wherein the cross section of the anti-rotation portion is wholly within the cross-section of the foot portion.
